(19) United States
(12) Patent Application Publication
(10) Pub. No.: US 2025/0392511 A1
(43) Pub. Date: Dec. 25, 2025

(54) DYNAMIC ADAPTATION OF TELECOMMUNICATION NETWORKS

(71) Applicant: International Business Machines Corporation, Armonk, NY (US)

(72) Inventors: Maja Curic, Munich (DE); Sagar Tayal, Ambala City (IN); Nir Rozenbaum, Yoqneam Illit (IL); Alecio Pedro Delazari Binotto, Munich (DE)

(21) Appl. No.: 18/750,842

(22) Filed: Jun. 21, 2024

(51) Int. Cl. H04L 41/082; H04L 41/0893; H04L 41/16; H04L 41/5041

(52) U.S. Cl. CPC H04L 41/082; H04L 41/0893; H04L 41/16; H04L 41/5045

(57) ABSTRACT

A computer-implemented method (CIM), according to one approach, includes logically grouping edge locations of a telecommunication network into different groups based on characteristics of the edge locations, and identifying, for each of the edge locations, operation baselines of artificial intelligence (AI) and/or machine learning (ML) models over a predetermined period of deployment of the models on the edge locations of the telecommunication network. The CIM further includes estimating, based on the operation baselines, future operation efficiencies of the AI and/or ML models deployed on the edge locations, determining a first update for increasing a first of the future operation efficiencies of the AI and/or ML models, and causing the first update to be performed within the telecommunication network.

### BACKGROUND

The present invention relates to telecommunications, and more specifically, this invention relates to telecommunication networks.

A telecommunication network includes a plurality of nodes that communicate with one another, e.g., exchange information and messages, via established links between the nodes. More specifically, the nodes of a telecommunication network may include physical components, e.g., such as a modem, a switch, a telephone, a host computer, a hub, etc. Furthermore, these links between nodes may enable communication via information exchange techniques, e.g., circuit switching, message switching, packet switching, etc.

### SUMMARY

A computer-implemented method (CIM), according to one approach, includes logically grouping edge locations of a telecommunication network into different groups based on characteristics of the edge locations, and identifying, for each of the edge locations, operation baselines of artificial intelligence (AI) and/or machine learning (ML) models over a predetermined period of deployment of the models on the edge locations of the telecommunication network. The CIM further includes estimating, based on the operation baselines, future operation efficiencies of the AI and/or ML models deployed on the edge locations, determining a first update for increasing a first of the future operation efficiencies of the AI and/or ML models, and causing the first update to be performed within the telecommunication network.

A computer program product (CPP), according to another approach, includes a set of one or more computer-readable storage media, and program instructions, collectively stored in the set of one or more storage media, for causing a processor set to perform the any combination of features of the foregoing methodology.

A computer system (CS), according to another approach, includes a processor set, a set of one or more computer-readable storage media, and program instructions, collectively stored in the set of one or more storage media, for causing the processor set to perform the following computer operations.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a table, in accordance with one approach of the present invention.

FIG. 4 is a table, in accordance with one approach of the present invention.

FIG. 5 is a flowchart of a method, in accordance with one approach of the present invention.

FIGS. 6A-6B are logical groupings, in accordance with several approaches of the present invention.

FIG. 7 is a table, in accordance with one approach of the present invention.

FIG. 8 is a table, in accordance with one approach of the present invention.

FIGS. 9A-9C are logical groupings, in accordance with several approaches of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamic adaptation of telecommunication networks.

In one general approach, a CIM includes logically grouping edge locations of a telecommunication network into different groups based on characteristics of the edge locations, and identifying, for each of the edge locations, operation baselines of artificial intelligence (AI) and/or machine learning (ML) models over a predetermined period of deployment of the models on the edge locations of the telecommunication network. The CIM further includes estimating, based on the operation baselines, future operation efficiencies of the AI and/or ML models deployed on the edge locations, determining a first update for increasing a first of the future operation efficiencies of the AI and/or ML models, and causing the first update to be performed within the telecommunication network.

A technical effect of automatically recognizing suboptimal performance of an AI/ML layer in a telecommunication network in the context of SLA impact and dynamically improving performance as the conditions of the edge vary includes the enablement of proactively updating the telecommunication network before performance within the telecommunication network deteriorates. This technical effect is enabled by performing estimations of the future operation efficiencies of the AI and/or ML models rather than otherwise reacting to instances of performance decreasing in the telecommunications network.

In approaches, the first update may include reconfiguring models of the AI and/or ML models. Reconfiguration of the models in the process of performing an update has a technical effect of causing deployments of AI and/or ML models to adjust to changing conditions in a telecommunications network. This way, AI and/or ML models do not remain deployed but unused in portions of the telecommunication network where doing so amounts to a wasted AI and/or ML resources.

In approaches, the first update may include redistributing at least some of the edge locations within the telecommunication network. Reconfiguration of the edge locations in the process of performing an update has a technical effect of causing deployments of edge locations to adjust to changing conditions in a telecommunications network. This way, AI and/or ML models do not remain deployed but unused in portions of the telecommunication network where doing so amounts to a wasted AI and/or ML resources.

In approaches, the characteristics of the edge locations may be selected from the one or more of: whether a majority of users of a given one of the edge locations are using ultra reliable low-latency communications (uRLLC), whether a majority of users of a given one of the edge locations are using enhanced mobile broadband (eMBB) services, whether a majority of users of a given one of the edge locations are using massive Machine Type Communications (mMTC), an availability of resources for storage at a given one of the edge locations, and an availability of spectrum at a given one of the edge locations.

A beneficial technical effect of performing the logical grouping of the edge locations of the telecommunication network into different groups includes establishing an up to date analysis, from a performance perspective, of the edge locations. Note that, the use of different characteristics increases the extent of detail that is incorporated into the logical grouping determinations. Furthermore, by determining these dynamic groupings over time as conditions of the edge locations change, performance of the edge locations may, in some approaches, be anticipated in order to ensure that AI and/or ML model deployment updates are performed before efficiencies decrease, e.g., proactive updates are performed rather than performing reactive updates.

In approaches, identifying the operation baselines of AI and/or ML models may include identifying, for each of the edge locations, an extent of development of fulfillment of an associated service level agreement (SLA) within a predetermined amount of time. Identifying the operation baselines of AI and/or ML models has the technical effect of understanding, over time, whether the AI and/or ML models are performing relatively efficiently, or relatively inefficiently. More specifically, because adherence to SLAs is considered a high priority goal, in some approaches, in the deployment of AI and/or ML models, basing the operation baselines of AI and/or ML models on the progression of fulfillment of a predetermined SLA observed over the predetermined amount of time has the technical effect of generating an observation as to whether deployment goals are being met over time. In the event that these goals are not being met (trending downwards), updates may be performed to mitigate a loss of performance (as will described elsewhere herein).

In approaches, identifying the operation baselines of AI and/or ML models may include identifying, for each of the edge locations, an extent of activity of the AI and/or ML models over the predetermined period of deployment, where the extent of activity is based on central processing unit (CPU) utilization and/or graphics processing unit (GPU) utilization.

In approaches, identifying the operation baselines of AI and/or ML models has the technical effect of understanding, over time, whether the AI and/or ML models are performing relatively efficiently, or relatively inefficiently. More specifically, because extent of activity of the AI and/or ML models may directly correlate to efficiencies, e.g., the AI and/or ML models being actively used for a benefit versus being deployed yet unused, in some approaches, basing the operation baselines of AI and/or ML models on the extent of activity observed over time has the technical effect of generating an observation as to whether the deployment of resources, e.g., the AI and/or ML models, is useful (actively used based on CPU utilization and/or GPU utilization) or a wasted deployment (not used based on a lack of CPU utilization and/or GPU utilization) are being met over time. In the event that a deployment is considered to be not useful, updates may be performed to mitigate a loss of performance that results from the deployment of AI and/or ML models that are never actually used (as will described elsewhere herein).

In approaches, estimating the future operation efficiencies of the AI and/or ML models deployed on the edge locations may include identifying, in a predetermined type of report, trends of development of condition(s) in the edge locations, logically re-grouping the edge locations based on the identified trends, checking an extent of development of fulfillment of an associated service level agreement (SLA) within a predetermined amount of time, and correlating the re-grouped edge locations with historical groupings. The estimated future operation efficiencies of the AI and/or ML models are based on the correlation.

Using one or more different factors to estimate the future operation efficiencies of the AI and/or ML models deployed on the edge locations has the technical effect of diversifying an extent of the considerations that are incorporated into the estimation.

In approaches, identifying the trends of development of condition(s) in the edge locations may include causing predetermined generative AI models to review domain condition reports and/or AI and ML reports to identify the trends. Causing predetermined generative AI models to review domain condition reports and/or AI and ML reports to identify the trends has the technical effect of ensuring that past data trends and responses thereto are considered when analyzing current conditions in the telecommunication network. This way, relatively less processing resources are expended while analyzing current conditions of the telecommunications network, because processing resources previously used to identify and store the trend are relied on.

In another general approach, a CPP includes a set of one or more computer-readable storage media, and program instructions, collectively stored in the set of one or more storage media, for causing a processor set to perform the any combination of features of the foregoing methodology. Similar technical effects are obtained.

In another general approach, a CS includes a processor set, a set of one or more computer-readable storage media, and program instructions, collectively stored in the set of one or more storage media, for causing the processor set to perform the following computer operations.

In another general approach, a CIM includes logically grouping edge locations of a telecommunication network into different groups based on characteristics of the edge locations, and identifying, for each of the edge locations, operation baselines of artificial intelligence (AI) and/or machine learning (ML) models over a predetermined period of deployment of the models on the edge locations of the telecommunication network. Identifying the operation baselines of AI and/or ML models may include identifying, for each of the edge locations, an extent of development of fulfillment of an associated SLA within a predetermined amount of time, and identifying, for each of the edge locations, an extent of activity of the AI and/or ML models over the predetermined period of deployment, where the extent of activity is based on CPU utilization and/or GPU utilization. The CIM further includes estimating, based on the operation baselines, future operation efficiencies of the AI and/or ML models deployed on the edge locations, determining a first update for increasing a first of the future operation efficiencies of the AI and/or ML models, and causing the first update to be performed within the telecommunication network.

A technical effect of automatically recognizing suboptimal performance of an AI/ML layer in a telecommunication network in the context of SLA impact and dynamically improving performance as the conditions of the edge vary includes the enablement of proactively updating the telecommunication network before performance within the telecommunication network deteriorates. This technical effect is enabled by performing estimations of the future operation efficiencies of the AI and/or ML models rather than otherwise reacting to instances of performance decreasing in the telecommunications network. Furthermore, within the context of SLAs, a technical effect of automatically recognizing suboptimal performance of an AI/ML layer in a telecommunication network includes ensuring that the SLAs are adhered to while processing resources associated with the deployment of AI and/or ML models on the edge locations are not wasted (which would otherwise be the case in the event that such resources were deployed but remained unused during the deployment).

In another general approach, a CIM includes a centralized entity, such as a non-RT RIC, performing operations for automatically recognizing suboptimal performance of an AI/ML layer in telecommunication network in the context of SLA impact and dynamically improving the telecommunication network as the conditions of the edge locations vary. The centralized entity may be configured and/or caused to logically group edge locations of the telecommunication network into different groups based on characteristics of the edge locations. These characteristics may be determined from information that is reported to the centralized entity based on the centralized entity being in communication with one or more distributed entities (near-RT RIC). The centralized entity may identify, for each of the edge locations, operation baselines of artificial intelligence (AI) and/or machine learning (ML) models over a predetermined period of deployment of the models on the edge locations of the telecommunication network, estimate, based on the operation baselines, future operation efficiencies of the AI and/or ML models deployed on the edge locations, determine a first update for increasing a first of the future operation efficiencies of the AI and/or ML models, and cause the first update to be performed within the telecommunication network.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as telecommunication network update code of block 150 for dynamic adaptation of telecommunication networks. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

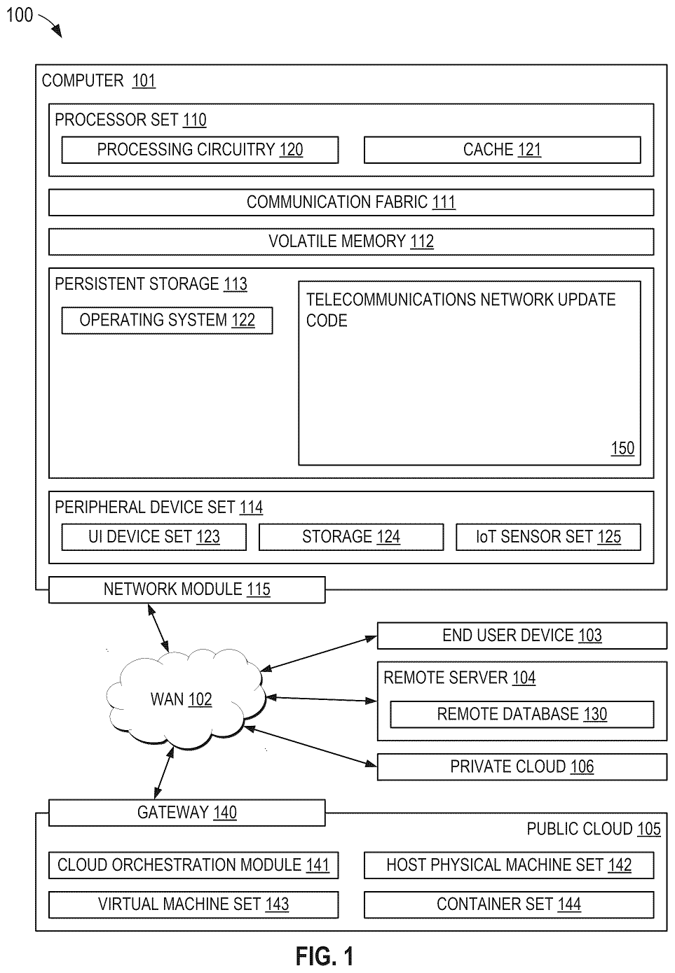

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, a telecommunication network includes a plurality of nodes that communicate with one another, e.g., exchange information and messages, via established links between the nodes. In some approaches, examples of telecommunication networks include computer networks, the Internet, wireless radio networks used by cell phone telecommunication providers, etc. The nodes of a telecommunication network may include physical components, e.g., such as a modem, a switch, a telephone, a host computer, a hub, etc. Furthermore, these links between nodes may enable communication via information exchange techniques, e.g., circuit switching, message switching, packet switching, etc.

Artificial intelligence (AI) and/or machine learning (ML) models may be deployed in telecommunication networks, however, an efficiency of the AI and/or ML models in telecommunication networks varies with conditions on the edge locations. Depending on these conditions, the AI and/or ML models may initially perform efficiently at different edge location placements, but thereafter perform inefficiently as conditions on the different edge locations change. Manual adjustments are unable to correct the inefficient performance of AI and/or ML models in these cases because edge location conditions typically change at a relatively faster rate than a rate that manual calculations and adjustments otherwise can be performed. For this reason, the technical field of telecommunication networks experience inefficiencies and wasted computing resources based on the fact that AI and/or ML models in telecommunication networks are not able to dynamically be updated as edge location conditions change.

In sharp contrast to the techniques described above, the techniques of approaches described herein mitigate the aforementioned inefficiencies of AI and/or ML model layers in dynamic telecommunication networks by reconfiguring and/or redistributing AI and/or ML models and/or edge locations (nodes) based on the similarity of usage patterns and network conditions, as well as an assessment of the current and future workload on the edge locations. In order to achieve this mitigation of the inefficiencies, techniques described herein perform logical groupings of edge locations in the telecommunication networks based on determined similar characteristics. Furthermore, these techniques dynamically identify AI and/or ML model operation baselines in the context of service level agreement (SLA) development and resource utilization over an observed period of time. Yet furthermore, these techniques perform estimation(s) of future efficiency of deployed AI and/or ML models on network edge locations based on historical network data. Some illustrative approaches for performing these techniques are described below, e.g., see method 200.

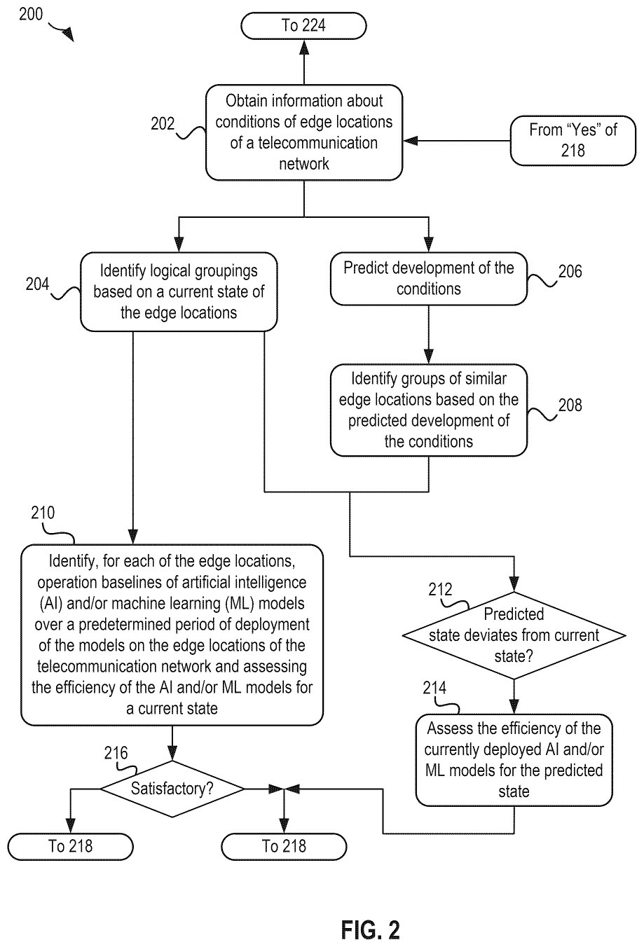

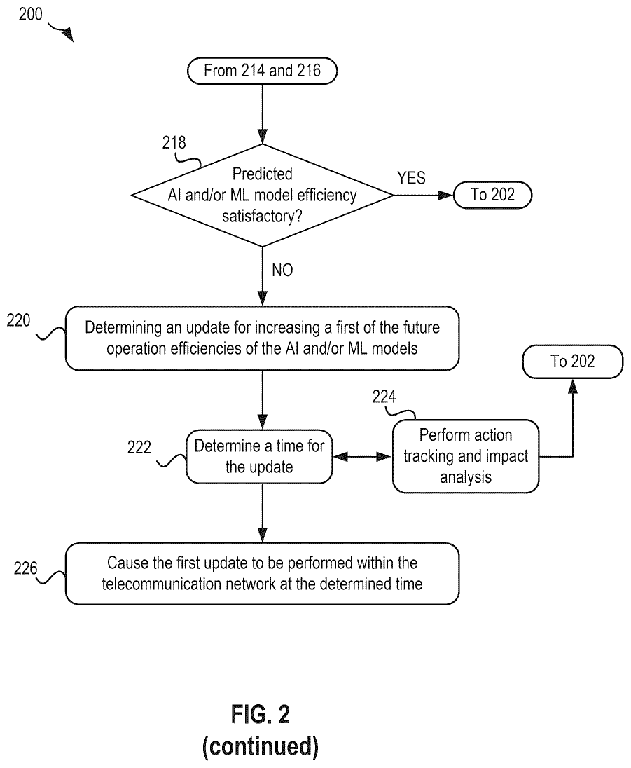

Now referring to FIG. 2, a flowchart of a method 200 is shown according to one approach. The method 200 may be performed in accordance with aspects of the present invention in any of the environments depicted in FIGS. 1-9C, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operations of method 200 enable automatic recognition of suboptimal performance of an AI and/or ML layer in a telecommunication network in the context of SLA impact, and dynamically improves performance as the conditions of different edge locations of the telecommunication network vary. These operations may, in some approaches, be performed by a processing circuit, e.g., which may be an AI and/or ML model, that is configured to oversee and/or automatically manage a telecommunication network. The telecommunication network may be of a type that would become apparent to one of ordinary skill in the art after reading the descriptions herein. Furthermore, the telecommunication network preferably includes a plurality of edge locations, which may be models of a type that would become apparent to one of ordinary skill in the art after reading the descriptions herein.

In order to oversee and/or automatically manage the telecommunication network, in some approaches, information about conditions of edge locations of a telecommunication network is obtained, e.g., see operation 202. The information may, in some approaches, be collected by one or more edge entities, e.g., near-RAN intelligent controller (RT RIC), that are caused, e.g., instructed, and/or pre-configured to obtain the information from edge sites, e.g., such as eNodeBs, report collected condition information. The conditions may, in some approaches, be types of information that define characteristics of the edge locations, e.g., infrastructure information, user plane conditions, user and/or service types, actions performed by AI and/or ML models currently deployed at the edge locations of the telecommunication network (non-RT RIC), etc.

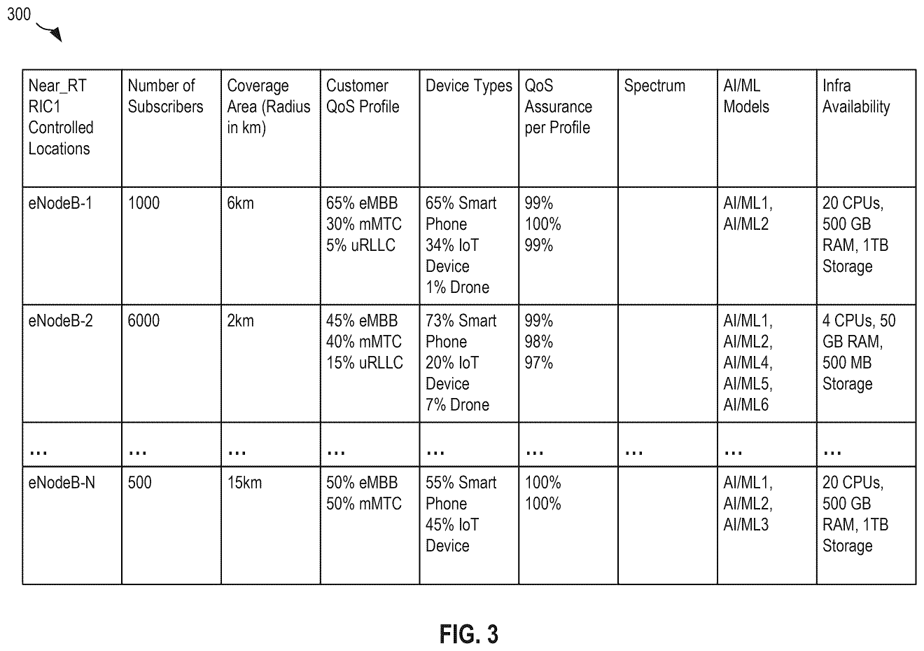

In some open radio access network (O-RAN) based approaches, the information may be obtained from an edge location that is a distributed entity. The distributed entity may be caused to continuously collect its own domain state, e.g., for each base station the entity may track a number of subscribers, active services, mobility patterns, etc. In order to prepare the information that is obtained, the distributed entity may, in some approaches, create AI and/or ML operations reports, e.g., take notes (record in a log) of the actions from algorithms of the AI and/or ML models, take notes on which edge locations the actions are impacting, effort (activity expended), etc. For illustrative approaches, FIG. 3, which is described in detail elsewhere herein, provides an example of a domain conditions report (sent from a distributed entity to a centralized entity) that may be obtained and used in operation(s) of method 200.

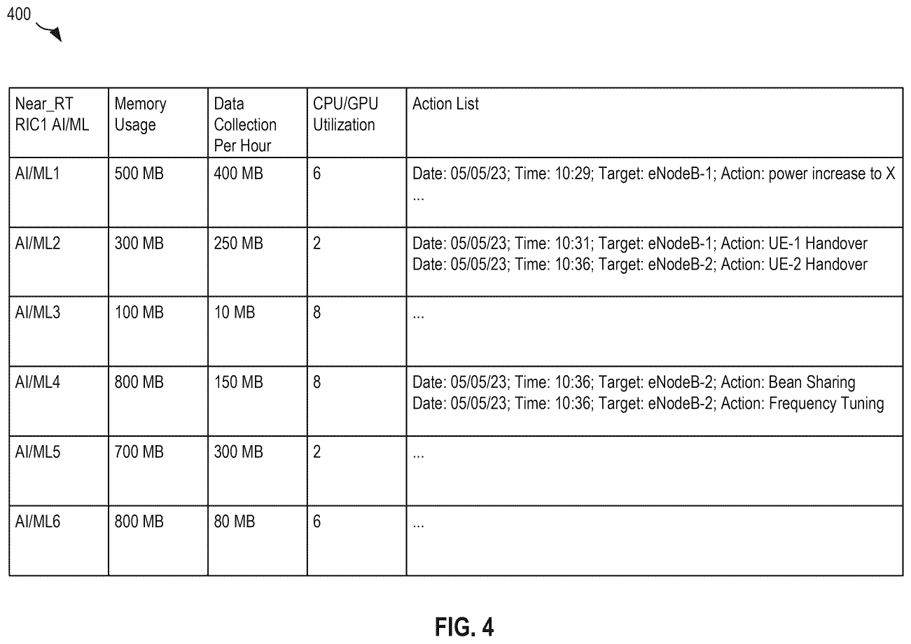

In contrast to some of the approaches above, in some other O-RAN based approaches, the information may be obtained from an edge location that is a centralized entity. The centralized entity may be caused, e.g., instructed, to periodically query a domain state from all distributed entities, e.g., see example of a domain conditions report in FIG. 3. The centralized entity may additionally and/or alternatively be caused to periodically query the AI and/or ML operation reports from all distributed entities. For illustrative approaches, FIG. 4, which is described in detail elsewhere herein, provides an example of an AI and/or ML operation report (a near-RT RIC AI and/or ML report within the controller domain).

The information is, in some approaches, obtained in order to know conditions of the edge locations of the telecommunication network. Because these conditions are likely to change over time, in response to a determination that the conditions of the edge location(s) change, a determination may be made as to whether updates should be performed in order to maintain or increase the operation efficiencies of the AI and/or ML models.

Operation 204 includes identifying and/or logically grouping the edge locations of the telecommunication network into different groups based on characteristics of the edge locations. More specifically, in some approaches, edge locations are preferably grouped with other edge locations having at least a predetermined degree of similarity for one or more predetermined characteristics (as determined from the obtained information). In some approaches, the similarities are determined and/or the grouping is performed by causing a K-means clustering model to analyze the information, where the logical groupings are determined as an output of the model.

A beneficial technical effect of performing the logical grouping of the edge locations of the telecommunication network into different groups includes establishing an up to date analysis, from a performance perspective, of the edge locations. By determining these dynamic groupings over time as conditions of the edge locations change, performance of the edge locations may, in some approaches, be anticipated in order to ensure that AI and/or ML model deployment updates are performed before efficiencies decrease, e.g., proactive updates are performed rather than performing reactive updates.

Various characteristics of the edge locations are described elsewhere above, Characteristics of the edge location may, in some approaches, additionally and/or alternatively include whether a majority of users of a given one of the edge locations are using ultra reliable low-latency communications (uRLLC), whether a majority of users of a given one of the edge locations are using enhanced mobile broadband (eMBB) services, whether a majority of users of a given one of the edge locations are using massive Machine Type Communications (mMTC), an availability of resources for storage at a given one of the edge locations, an availability of spectrum at a given one of the edge locations, etc.

Some illustrative approaches for logically grouping the edge locations with similar characteristics (in accordance with operation 204) are detailed below.

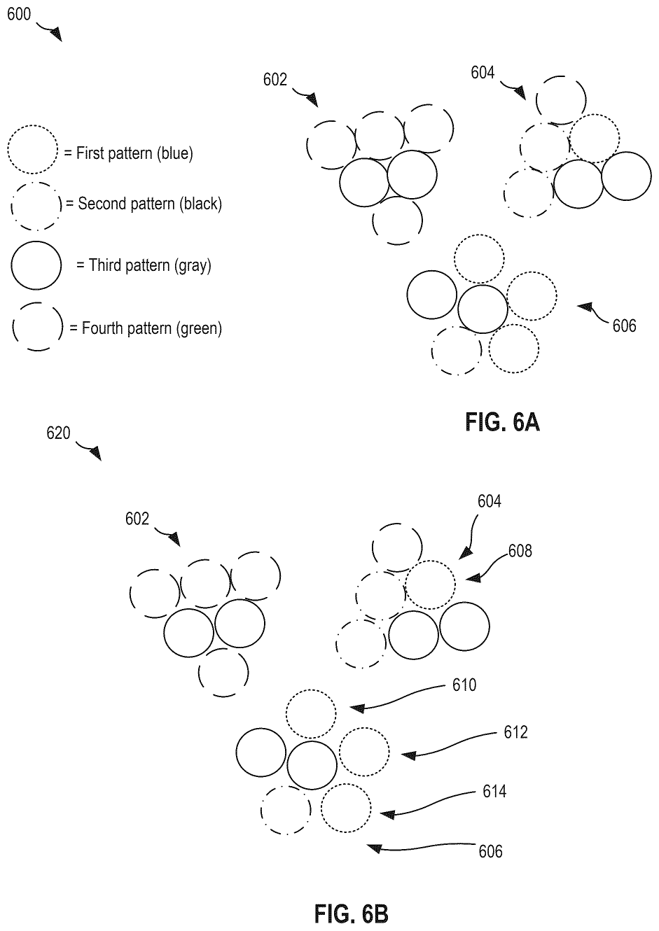

In some approaches, based on one or more consecutive domain condition reports obtained from the distributed entities, a centralized entity may identify and/or be caused to identify development of the conditions for each individual edge location within each domain. Logical groups for the edge locations with similar development of user and/or control plane conditions and/or similar infrastructure may be automatically created. An example of such grouping is described in further detail elsewhere herein, e.g., see FIG. 6A in which different circle patterns are used to depict edge locations with different conditions (including both user behavior as well as the infrastructure availability). In some approaches, at least some of the groupings may be based on whether a majority of users (using user device using the edge locations) are using ultra reliable low-latency communications (uRLLC), e.g., a first pattern may be used to visually represent edge locations with more than 50% or 50% of CPU/GPU available while a second pattern may be used to visually represent edge locations with less than 50% of CPU/GPU available. In some other approaches, at least some of the groupings may additionally and/or alternatively be based on whether a majority of users (using user device using the edge locations) are using enhanced mobile broadband (eMBB) services, e.g., a third pattern may be used to visually represent edge locations with more than 50% or 50% of CPU/GPU available while a fourth pattern may be used to visually represent edge locations with less than 50% of CPU/GPU available. In yet some other approaches, at least some of the groupings may additionally and/or alternatively be based on whether a majority of users are using massive Machine Type Communications (mMTC), e.g., a fifth pattern may be used to visually represent edge locations with more than 50% or 50% of CPU/GPU available while a sixth pattern may be used to visually represent edge locations with less than 50% of CPU/GPU available.

It should be noted that the logical grouping possibilities described herein are, in some approaches, not limited to the above provided examples. The logical groupings may additionally and/or alternatively be made possible by leveraging other user and/or control plane conditions and infrastructure characteristics, e.g., an availability of resources for storage, available spectrum at the edge locations, etc. It may further be noted that the classification of the edge locations may be important in telecommunication environments in which the techniques described herein are deployed, as conditions on the edge locations can significantly vary, in some approaches, from a network perspective, e.g., spectrum, vendor, infrastructure, configurations, etc., and/or from a user perspective, e.g., handsets in use, usage patterns, mobility patterns, SLA requirements, etc.

Operation 210 includes dynamic identifying, for each of the edge locations, operation baselines of the AI and/or ML models (the AI and/or ML models currently deployed on the edge locations) over a predetermined period of deployment of the models being deployed on the edge locations of the telecommunication network. In some preferred approaches, the operational baselines are baselines of the AI and/or ML models in the context of service level agreement (SLA) development and resource utilization over the observed period of time.

Preferred techniques for identification of AI and/or ML model operation baselines in the context of SLA development and resource utilization over the observed period of time are described below, according to some approaches.

In some approaches, identifying the operation baselines of AI and/or ML models includes identifying, for each of the edge locations (the identified edge locations), an extent of development of fulfillment of an associated SLA within a predetermined amount of time (which may be the observed period of time). The non-RT RIC, in some approaches, is caused to analyze each logical group of edge locations identified in operations described elsewhere above. For context, the development of fulfillment of an associated SLA may be defined as a progression of fulfillment of a predetermined SLA (from an initial amount of fulfillment to a final amount of fulfillment) observed over the predetermined amount of time. An illustrative example of such progression includes a determined improvement from unfulfilled to fulfilled SLAs for 99% of the users using user devices associated with a given one of the edge locations over a predetermined period, e.g., within 5 seconds.

In some approaches in which identifying the operation baselines of AI and/or ML models includes identifying extents of development of fulfillment of associated SLAs, a plurality of predetermined factors may be tracked for each observed SLA development (the non-RT RIC may be caused to track). A first of the predetermined factors includes near-RT RIC ID, cell ID, cell classification (a pattern used to represent the logical groupings), etc. In another approach, the predetermined factors may additionally and/or alternatively include the group (e.g., a first pattern from one of the Near-RT RIC domains) for which the development was observed. In yet another approach, the predetermined factors may additionally and/or alternatively include AI and/or ML model algorithms that are running at the time of the observed developments. In yet some other approaches, the predetermined factors may additionally and/or alternatively include resources that were utilized by the AI and/or ML models to cause the developments. In yet another approach, the predetermined factors may additionally and/or alternatively include the presence of other logical groups that are controlled by the same near-RT RIC (e.g., another pattern from the Near-RT RIC 3 domain).

Identifying the operation baselines of AI and/or ML models has the technical effect of understanding, over time, whether the AI and/or ML models are performing relatively efficiently, or relatively inefficiently. More specifically, because adherence to SLAs is considered a high priority goal, in some approaches, in the deployment of AI and/or ML models, basing the operation baselines of AI and/or ML models on the progression of fulfillment of a predetermined SLA observed over the predetermined amount of time has the technical effect of generating an observation as to whether deployment goals are being met over time. In the event that these goals are not being met (trending downwards), updates may be performed to mitigate a loss of performance (as will be described elsewhere herein).

In some other approaches, identifying the operation baselines of AI and/or ML models may additionally and/or alternatively include identifying, for each of the edge locations, an extent of activity of the AI and/or ML models over the predetermined period of deployment. The extent of activity may be based on CPU utilization and/or GPU utilization of infrastructure used by the AI and/or ML models. In one illustrative approach based on the context of the activity of the AI and/ML models, the extent of activity of the AI and/or ML models over the predetermined period of deployment may include improvements to performance being observed with not more than a predetermined extent of CPU and/or GPU utilization, e.g., at least 10% utilization, at least 20% utilization, at least 30% utilization, etc.

Identifying the operation baselines of AI and/or ML models has the technical effect of understanding, over time, whether the AI and/or ML models are performing relatively efficiently, or relatively inefficiently. More specifically, because extent of activity of the AI and/or ML models may directly correlate to efficiencies, e.g., the AI and/or ML models being actively used for a benefit versus being deployed yet unused, in some approaches, basing the operation baselines of AI and/or ML models on the extent of activity observed over time has the technical effect of generating an observation as to whether the deployment of resources, e.g., the AI and/or ML models, is useful (actively used based on CPU utilization and/or GPU utilization) or a wasted deployment (not used based on a lack of CPU utilization and/or GPU utilization) are being met over time. In the event that a deployment is considered to be not useful, updates may be performed to mitigate a loss of performance that results from the deployment of AI and/or ML models that are never actually used (as will be described elsewhere herein).

Method 200 includes estimating, based at least in part on the operation baselines, future AI and/or ML operation efficiencies of the AI and/or ML models deployed on the edge locations. In some preferred approaches, these estimations are performed by predicting development of the conditions, e.g., see operation 206. Techniques for predicting development of the conditions, in some approaches, are based on historical network data. For example, estimating the future operation efficiencies of the AI and/or ML models deployed on the edge locations may include, identifying, in a predetermined type of report, trends of development of condition(s) in the individual edge locations, e.g., see operation 208. For example, linear extrapolation techniques of a type that would become apparent to one of ordinary skill in the art after reading the descriptions herein may be used to generate predicted points on a graph based on conditions of historical network data. In some other approaches, identifying the trends of development of condition(s) in the edge locations includes causing predetermined generative AI models to review domain condition reports and/or AI and ML reports to identify the trends. These trends may also be used to correlate past conditions and performance data for the AI and/or ML models with current and/or predicted conditions to determine whether current operation efficiencies of the AI and/or ML models should be increased by performing deployment updates. In order to incorporate a sustainable and dynamic nature to the techniques described herein, estimating the future operation efficiencies of the AI and/or ML models deployed on the edge locations may additionally and/or alternately include logically re-grouping the edge locations based on the identified trends (and/or predicted future conditions based on the identified trends). Estimating the future operation efficiencies of the AI and/or ML models deployed on the edge locations may additionally and/or alternately include checking an extent of development of fulfillment of an associated service level agreement (SLA) within a predetermined amount of time, and correlating the re-grouped edge locations with historical groupings, where the estimated future operation efficiencies of the AI and/or ML models are based on the correlation. Furthermore, in some approaches, the estimated future operation efficiencies of the AI and/or ML models may be output, e.g., to a predetermined log, to an engine configured to determine an update, etc.

Causing predetermined generative AI models to review domain condition reports and/or AI and ML reports to identify the trends has the technical effect of ensuring that past data trends and responses thereto are considered when analyzing current conditions in the telecommunication network. This way, relatively less processing resources are expended while analyzing current conditions of the telecommunications network, because processing resources previously used to identify and store the trend are relied on.

Using one or more different factors to estimate the future operation efficiencies of the AI and/or ML models deployed on the edge locations has the technical effect of diversifying an extent of the considerations that are incorporated into the estimation.

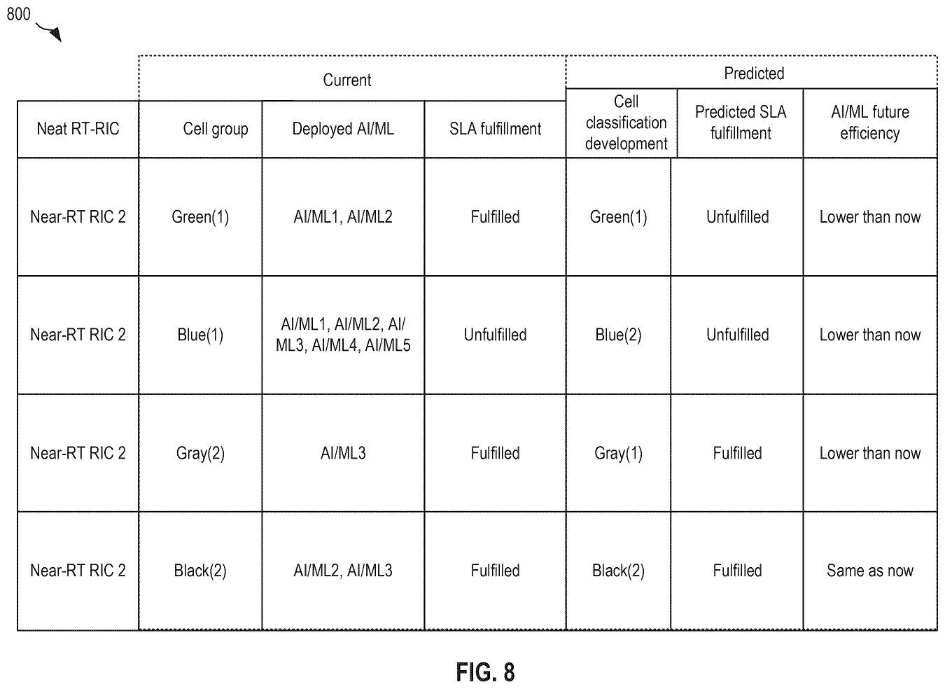

Note that, in some approaches, a maintained table that may be used to identify cell classification development may be used to perform the logical re-groupings described above (e.g., see FIG. 8). For example, such a table may, in some approaches, be an SLA development tracker table that may be used to find historical reports for a same or similar (within at least a predetermined degree of similarity) combination of the predicted cell groups and the same AI and/or ML models. Based on these findings, a predicted future AI and/or ML model efficiency may be output.

In some preferred approaches, the predicted states of the telecommunication network may be used to determine whether an update should be performed to current AI and/or ML model deployment in the telecommunication network to maintain and/or increase operation efficiencies of the AI and/or ML models. For example, a determination may be made as to whether predicted conditions (also referred to as a predicted state) deviate from current conditions (also referred to as a current state), e.g., see decision 212.

In some approaches, this determination is made by assessing, e.g., predicting using the trend-based techniques described herein, the efficiency of the currently deployed AI and/or ML models for the predicted state, e.g., see operation 214. A determination may be made as to whether considered efficiencies of deployed AI and/or ML models within the network environment are satisfactory, e.g., see decision 216. In some approaches, these efficiencies are considered to be satisfactory in response to a determination that the efficiencies are greater than a predetermined threshold, e.g., such as a historical average. In some other approaches, these efficiencies are considered satisfactory in response to a determination that efficiencies of the predicted state are greater than efficiencies of the current state. In some preferred approaches, the current and predicted efficiency of the AI and/or ML model are compared, and a determination is made as to whether an action is needed to maintain or increase efficiency. In some approaches, such an action is performed in order to ensure that an SLA that would not otherwise be fulfilled will be fulfilled. A first cases that is possible for the observed edge locations, in some approaches, includes the current efficiency is satisfactory, and the predicted efficiency is not satisfactory. In response to a determination that such a case is true, an update is preferably performed. In another case, both current and predicted efficiency are not satisfactory, e.g., see example cases in FIG. 8. In response to a determination that such a case is true, an update is preferably performed.

The method optionally continues to decision 218 at which different operations may be performed based on whether or not the efficiencies of the AI and/or ML models are determined to be satisfactory. In response to a determination that the AI and/or ML models are satisfactory, e.g., as illustrated by the “YES” logical path of decision 218, the method optionally continues to operation 202. In contrast, in response to a determination that the AI and/or ML models are not satisfactory, e.g., as illustrated by the “NO” logical path of decision 218, an update for increasing one or more of the future operation efficiencies, e.g., such as a first future operation efficiency, of the AI and/or ML models may be determined, e.g., see operation 220. The first update is preferably capable of increasing, e.g., designed for, estimated to be capable of, predicted to be capable of, etc., at least a first of the future AI and/or ML operation efficiencies of the AI and/or ML models. Various approaches below detail potential updates that may be made to increase one or more of the future operation efficiencies.

In some approaches, the first update that may be made to increase one or more of the future operation efficiencies includes reconfiguring models of the AI and/or ML models. In another approach, the first update may additionally and/or alternatively include redistributing at least some of the edge locations within the telecommunication network. Depending on the approach, this redistribution may include redistributing at least some of the edge locations to a different Near-RT RIC in order to increase their operations efficiencies. In some other approaches, this redistribution may include reconfiguring the AI and/or ML models or turning off one or more of the models in case the models are supporting traffic that is not utilized anymore by the user devices on one or more of the edge locations. Reconfiguration of the models and/or edge locations in the process of performing an update has a technical effect of causing deployments of AI and/or ML models and/or edge locations to adjust to changing conditions in a telecommunications network. This way, AI and/or ML models do not remain deployed but unused in portions of the telecommunication network where doing so amounts to a wasted AI and/or ML resources.

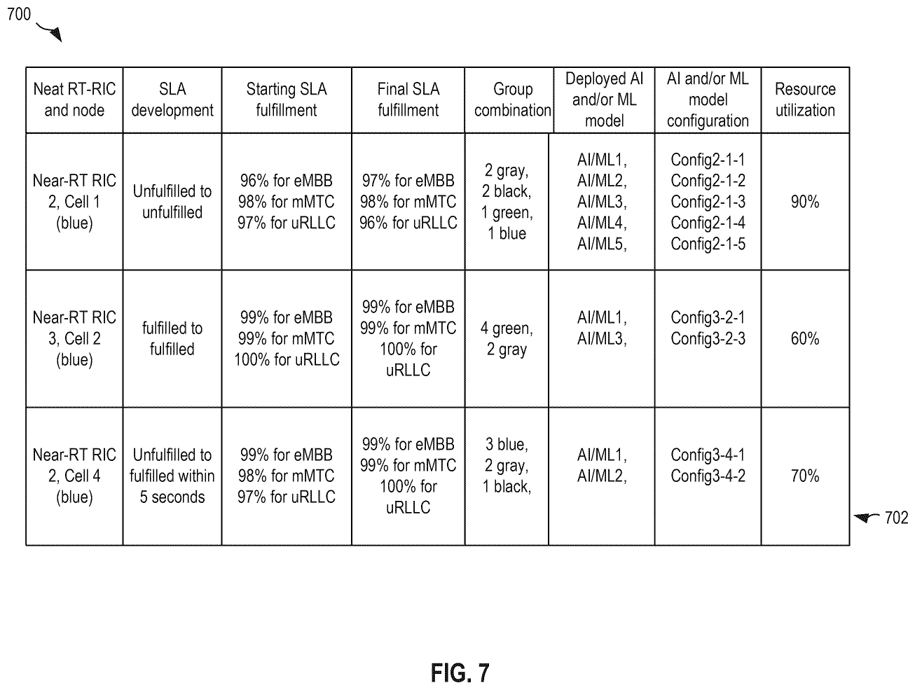

Illustrative approaches for optimizing efficiency of the AI and/or ML model layer in the highly dynamic telecommunication environments described herein reconfigure or redistribute AI/ML models and/or edge nodes based on the similarity of usage patterns and network conditions and assessment of the current and future workload on the edge locations. In such cases, historical data may be leveraged from the SLA development tracker described elsewhere herein, e.g., see FIG. 7. In order to leverage such data, in at least some of the illustrative approaches, alternatives in the AI and/or ML model configurations may be considered by comparing AI and/or ML model configurations from the SLA development tracker for the domains where the same and/or ML model are deployed and the same combinations of classified cells are attached. However, it should be noted that one experiences relatively better SLA fulfilment and efficiency than the other and may therefore be preferable. Furthermore, in some approaches, the alternative and/or ML model deployments may be considered by comparing and/or ML model deployments from the SLA development tracker for the domains in which the same combinations of classified cells are attached and different and/or ML models are deployed. Again, one experiences relatively better SLA fulfilment and efficiency than the other and may therefore be preferable. In some other approaches, potential redistribution of the edge locations across the Near-RT RICs may be pursued, e.g., in cases in which the two previous considerations are considered but do not produce any alternative.

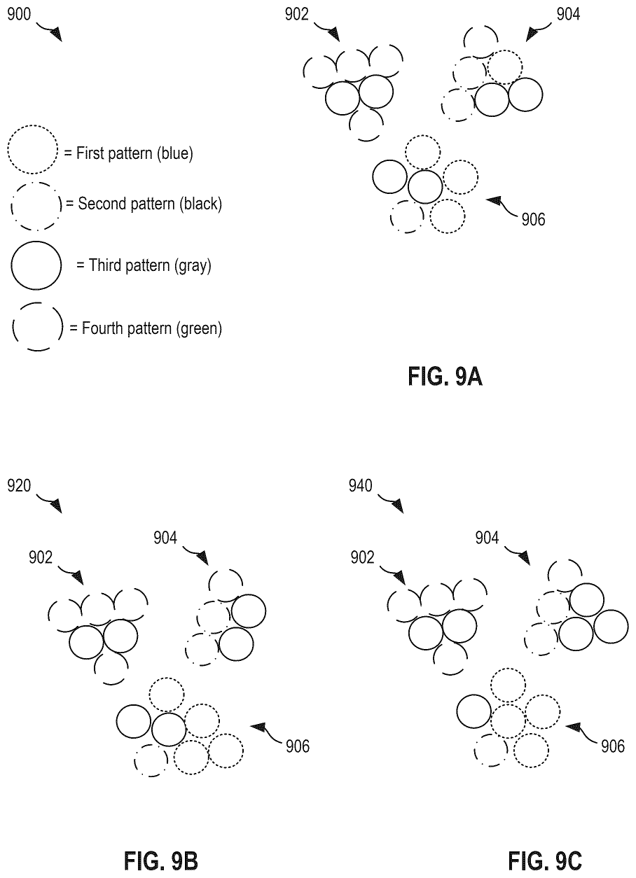

In some illustrative approaches, an observation may be made that the AI and/or ML model efficiency is not optimal. Assuming that no alternative configurations or deployments of the AI and/or ML model are possible, two alternative deployments of the edge locations may be determined, e.g., as shown in FIGS. 9B and 9C.

With continued reference to method 200, in some approaches, an optimal time for a determined update (a time for the identified action to be performed) may be determined, e.g., see operation 222. In one or more of such approaches, a determination may be made that the update should be performed immediately (reactive operation), or in some alternate approaches, the update may be performed at some point in the future (proactive operation). For the latter, the output from generative AI models may be leveraged and used in support of the future state prediction techniques described elsewhere herein. More specifically, these techniques may be used to determine that the update should be performed at time “T1”, while considering an offset, e.g., at time T2, that is necessary for the action to occur before the predicted state develops and potentially impairs the SLAs of the users. Accordingly, in some approaches, the update may optionally be executed at the time T1-T2.

After each action, the algorithms used in method 200 preferably are used to analyze an action impact (using post-analysis techniques of a type that would become apparent to one of ordinary skill in the art after reading the descriptions herein), and track the impact for future reference, e.g., operation 224.

Operation 226 includes causing, e.g., instructing, the first update to be performed within the telecommunication network.

A technical effect of automatically recognizing suboptimal performance of an AI/ML layer in a telecommunication network in the context of SLA impact and dynamically improving performance as the conditions of the edge vary includes the enablement of proactively updating the telecommunication network before performance within the telecommunication network deteriorates. This technical effect is enabled by performing estimations of the future operation efficiencies of the AI and/or ML models rather than otherwise reacting to instances of performance decreasing in the telecommunications network.

FIG. 3 depicts a domain conditions report 300, in accordance with one approach. As an option, the present domain conditions report 300 may be implemented in conjunction with features from any other approach listed herein, such as those described with reference to the other FIGS. Of course, however, such domain conditions report 300 and others presented herein may be used in various applications and/or in permutations which may or may not be specifically described in the illustrative approaches listed herein. Further, the domain conditions report 300 presented herein may be used in any desired environment.

The domain conditions report 300 may, in some approaches, be obtained from a distributed entity and/or at a centralized entity (that receives the report from the distributed entity) in accordance with obtaining information about a plurality of edge locations. The information of the domain conditions report 300 may be used to logically group the edge locations into different groups based on characteristics of the edge locations. For example, techniques described elsewhere above in method 200 may be used to performing such logical groupings.

FIG. 4 depicts a near-RT RIC AI and/or ML model report 400, in accordance with one approach. As an option, the present near-RT RIC AI and/or ML model report 400 may be implemented in conjunction with features from any other approach listed herein, such as those described with reference to the other FIGS. Of course, however, such near-RT RIC AI and/or ML model report 400 and others presented herein may be used in various applications and/or in permutations which may or may not be specifically described in the illustrative approaches listed herein. Further, the near-RT RIC AI and/or ML model report 400 presented herein may be used in any desired environment.

The near-RT RIC AI and/or ML model report 400 may, in some approaches, be obtained from a centralized entity and/or at distributed entities (that receive the reports from the centralized entity) in accordance with obtaining information about a plurality of edge locations. The information of the near-RT RIC AI and/or ML model report 400 may be used to logically group the edge locations into different groups based on characteristics of the edge locations. For example, techniques described elsewhere above in method 200 may be used to performing such logical groupings.

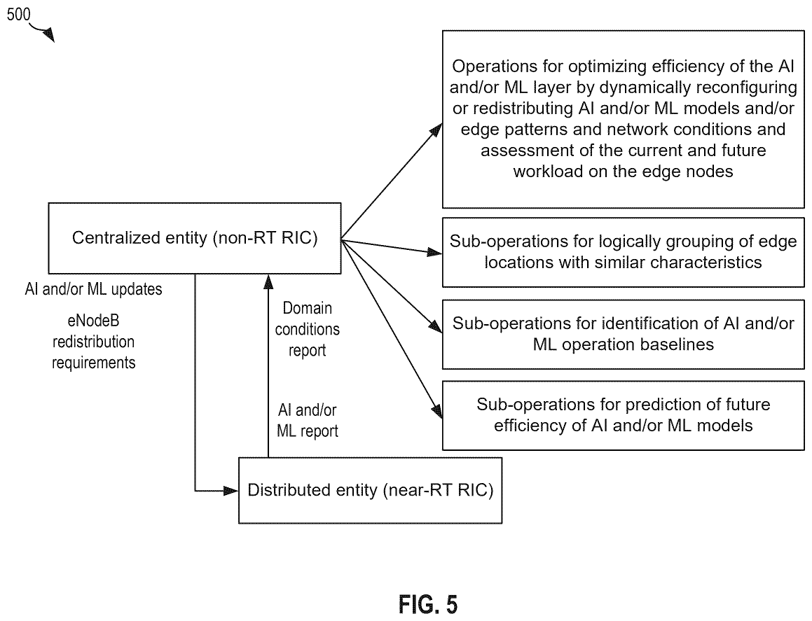

Now referring to FIG. 5, a flowchart of a method 500 is shown according to one approach. The method 500 may be performed in accordance with aspects of the present invention in any of the environments depicted in FIGS. 1-9C, among others, in various approaches. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various approaches, the method 500 may be partially or entirely performed by a centralized entity (non-RT RIC), or some other device having one or more processors therein. The processor, e.g., processing circuit(s), chip(s), and/or module(s) implemented in hardware and/or software, and preferably having at least one hardware component, may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 500 includes some operations that highlight (at a relatively high level) operations of method 200. In some approaches, a first of these highlighted operations, which may be performed by the centralized entity (non-RT RIC) includes operations for optimizing efficiency of the AI and/or ML layer by dynamically reconfiguring or redistributing AI and/or ML models and/or edge patterns and network conditions and assessment of the current and future workload on the edge nodes. Sub-operations for logically grouping of edge locations with similar characteristics may utilize techniques similar to those described elsewhere herein for logically grouping the edge locations described in method 200. Furthermore, sub-operations for identification of AI and/or ML operation baselines may utilize techniques similar to those described elsewhere herein for determining operation baselines described in method 200. Also, sub-operations for prediction of future efficiency of AI and/or ML models may utilize techniques similar to those described elsewhere herein for predicting future conditions described in method 200.

The operations and/or sub-operations described above for method 500 may be based on information that is obtained by the centralized entity non-RT RIC from a distributed entity (neat-RT RIC), e.g., domain condition reports, AI and/or ML module reports, etc.

FIGS. 6A-6B depict logical groupings 600 and 620, in accordance with one approach. As an option, the present logical groupings 600 and 620 may be implemented in conjunction with features from any other approach listed herein, such as those described with reference to the other FIGS. Of course, however, such logical groupings 600 and 620 and others presented herein may be used in various applications and/or in permutations which may or may not be specifically described in the illustrative approaches listed herein. Further, the logical groupings 600 and 620 presented herein may be used in any desired environment.

Referring first to FIG. 6A, the logical groupings 602, 604 and 606 are initial logical groupings based on characteristics of the edge locations of the groupings. More specifically, the logical grouping 602 are a domain of near-RT RIC1, the logical grouping 604 are a domain of near-RT RIC2 and the logical grouping 606 are a domain of near-RT RIC3.

The logical groupings are dynamically updated as conditions of a network environment that includes the edge locations change. Referring to FIG. 6B, conditions of the edge locations are monitored. For example, an estimation may be made that future operation efficiencies of the AI and/or ML models deployed on a first of the edge locations 608 of the logical grouping 604 will decrease based on SLAs determined to be currently unfulfilled being predicted (based on a comparison of CPU/GPU load A with CPU/GPU load A) to remain unfulfilled in the future. Furthermore, an estimation may be made that future operation efficiencies of the AI and/or ML models deployed on a first of the edge locations 610 of the logical grouping 606 will be maintained based on SLAs determined to be currently fulfilled being predicted to remain fulfilled in the future. An estimation may be made that future operation efficiencies of the AI and/or ML models deployed on a second of the edge locations 612 of the logical grouping 606 will be increase based on SLAs determined to be currently unfulfilled being predicted to be fulfilled in the future. An estimation may be made that future operation efficiencies of the AI and/or ML models deployed on a third of the edge locations 614 of the logical grouping 606 will be increase based on SLAs determined to be currently unfulfilled being observed to be fulfilled within five seconds (based on a comparison of CPU/GPU load C, a data collection rate D, etc.).

FIG. 7 depicts an SLA development tracker table 700, in accordance with one approach. As an option, the present an SLA development tracker table 700 may be implemented in conjunction with features from any other approach listed herein, such as those described with reference to the other FIGS. Of course, however, such an SLA development tracker table 700 and others presented herein may be used in various applications and/or in permutations which may or may not be specifically described in the illustrative approaches listed herein. Further, the SLA development tracker table 700 presented herein may be used in any desired environment.

A presence of other groups that are controlled by the same Near-RT RIC is important for identification on how presence of different groups within the same Near-RT RIC impacts the SLA development with specific AI and/or ML model deployment. For example, the SLA development from FIGS. 6A-6B in the Near-RT RIC 2 domain for the edge locations classified by the first pattern (blue) are not satisfactory due to the presence of the edge locations classified by the fourth pattern (green), while the same AI and/or ML models are deployed on both Near-RT RIC 2 and Near-RT RIC 3. An example SLA development tracker that illustrates the development of these logical groupings is shown in the FIG. 7. For example, the above described analysis of the SLA development across the network may be continuously performed (by the non-RT RIC), and the SLA development tracker table may be updated based on the analysis (which is important input for determining how to update the AI and/or ML models over time).

It may be noted that the row 702 may be determined to include a relatively best observed improvement for an AI and/or ML model classified by the first pattern (blue). This is because SLA development of the Near-RT RIC 2, Cell 4 (blue) develops from unfulfilled to fulfilled (where the development is noted in the increases between the percentages within the “Starting SLA fulfillment” column to the “Final SLA fulfillment” column.

FIG. 8 depicts a predicted condition state change table 800, in accordance with one approach. As an option, the present predicted condition state change table 800 may be implemented in conjunction with features from any other approach listed herein, such as those described with reference to the other FIGS. Of course, however, such predicted condition state change table 800 and others presented herein may be used in various applications and/or in permutations which may or may not be specifically described in the illustrative approaches listed herein. Further, the predicted condition state change table 800 presented herein may be used in any desired environment.

The predicted condition state change table 800 illustrates current versus predicted condition states for a plurality of different logical groupings of edge locations, e.g., see cell groups. The predicted condition state change table 800 may be used for optimizing efficiency of the AI and/or ML layers in highly dynamic telecommunication environments by reconfiguring or redistributing AI and/or ML models and/or edge nodes based on the similarity of usage patterns and network conditions and assessment of the current and future workload on the edge nodes. For example, a centralized entity may be caused to compare the current and predicted efficiency of a given AI and/or ML model and identifies if an action is necessary, e.g., in response to a determination that an SLA will not be fulfilled. In some approaches, the following cases are possible for the observed locations: the current efficiency is satisfactory, and the predicted efficiency is not satisfactory; and both current and predicted efficiency are not satisfactory (as in the example in FIG. 8).

FIGS. 9A-9C depict logical groupings of edge locations 900, 920 and 940, in accordance with several approaches. As an option, the present logical groupings of edge locations 900, 920 and 940 may be implemented in conjunction with features from any other approach listed herein, such as those described with reference to the other FIGS. Of course, however, such logical groupings of edge locations 900, 920 and 940 and others presented herein may be used in various applications and/or in permutations which may or may not be specifically described in the illustrative approaches listed herein. Further, the logical groupings of edge locations 900, 920 and 940 presented herein may be used in any desired environment.

Referring first to FIG. 9A, the logical grouping of edge locations 900 includes three initial deployment logical groupings, e.g., a domain of near-RT RIC1 902, a domain of near-RT RIC2 904 and a domain of near-RT RIC3 906.

Techniques described herein for determining updates for increasing at least a first of the future operation efficiencies of the AI and/or ML models may be used to determine different potential logical groupings of the initial deployments. For example, referring now to FIG. 9B-9C, two alternative deployments for increased AI and/or ML model logical groupings may be determined and evaluated. In logical grouping of edge locations 920, the blue cell (first pattern) is attached to the Near-RT RIC 3, where SLAs are fulfilled for blue cells. In another option, in logical grouping of edge locations 940, the blue cell is attached to the Near-RT RIC 3 while one gray cell from the Near-RT RIC 3 domain is attached to the Near-RT RIC 2.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method (CIM), the CIM comprising:
logically grouping edge locations of a telecommunication network into different groups based on characteristics of the edge locations;
identifying, for each of the edge locations, operation baselines of artificial intelligence (AI) and/or machine learning (ML) models over a predetermined period of deployment of the models on the edge locations of the telecommunication network;
estimating, based on the operation baselines, future operation efficiencies of the AI and/or ML models deployed on the edge locations;
determining a first update for increasing a first of the future operation efficiencies of the AI and/or ML models; and
causing the first update to be performed within the telecommunication network.

2. The CIM of claim 1, wherein the first update includes reconfiguring models of the AI and/or ML models.

3. The CIM of claim 2, wherein the first update includes redistributing at least some of the edge locations within the telecommunication network.

4. The CIM of claim 1, wherein the characteristics of the edge locations are selected from the group consisting of: whether a majority of users of a given one of the edge locations are using ultra reliable low-latency communications (uRLLC), whether a majority of users of a given one of the edge locations are using enhanced mobile broadband (eMBB) services, whether a majority of users of a given one of the edge locations are using massive Machine Type Communications (mMTC), an availability of resources for storage at a given one of the edge locations, and an availability of spectrum at a given one of the edge locations.

5. The CIM of claim 1, wherein identifying the operation baselines of AI and/or ML models includes identifying, for each of the edge locations, an extent of development of fulfillment of an associated service level agreement (SLA) within a predetermined amount of time.

6. The CIM of claim 5, wherein identifying the operation baselines of AI and/or ML models includes identifying, for each of the edge locations, an extent of activity of the AI and/or ML models over the predetermined period of deployment, wherein the extent of activity is based on central processing unit (CPU) utilization and/or graphics processing unit (GPU) utilization.

7. The CIM of claim 1, wherein estimating the future operation efficiencies of the AI and/or ML models deployed on the edge locations includes: identifying, in a predetermined type of report, trends of development of condition(s) in the edge locations; logically re-grouping the edge locations based on the identified trends; checking an extent of development of fulfillment of an associated service level agreement (SLA) within a predetermined amount of time; and correlating the re-grouped edge locations with historical groupings, wherein the estimated future operation efficiencies of the AI and/or ML models are based on the correlation.

8. The CIM of claim 7, wherein identifying the trends of development of condition(s) in the edge locations includes causing predetermined generative AI models to review domain condition reports and/or AI and ML reports to identify the trends.

9. A computer program product (CPP), the CPP comprising:
a set of one or more computer-readable storage media; and
program instructions, collectively stored in the set of one or more storage media, for causing a processor set to perform the following computer operations:
logically group edge locations of a telecommunication network into different groups based on characteristics of the edge locations;
identify, for each of the edge locations, operation baselines of artificial intelligence (AI) and/or machine learning (ML) models over a predetermined period of deployment of the models on the edge locations of the telecommunication network;
estimate, based on the operation baselines, future operation efficiencies of the AI and/or ML models deployed on the edge locations;
determine a first update for increasing a first of the future operation efficiencies of the AI and/or ML models; and
cause the first update to be performed within the telecommunication network.

10. The CPP of claim 9, wherein the first update includes reconfiguring models of the AI and/or ML models.

11. The CPP of claim 10, wherein the first update includes redistributing at least some of the edge locations within the telecommunication network.

12. The CPP of claim 9, wherein the characteristics of the edge locations are selected from the group consisting of: whether a majority of users of a given one of the edge locations are using ultra reliable low-latency communications (uRLLC), whether a majority of users of a given one of the edge locations are using enhanced mobile broadband (eMBB) services, whether a majority of users of a given one of the edge locations are using massive Machine Type Communications (mMTC), an availability of resources for storage at a given one of the edge locations, and an availability of spectrum at a given one of the edge locations.

13. The CPP of claim 9, wherein identifying the operation baselines of AI and/or ML models includes identifying, for each of the edge locations, an extent of development of fulfillment of an associated service level agreement (SLA) within a predetermined amount of time.

14. The CPP of claim 13, wherein identifying the operation baselines of AI and/or ML models includes identifying, for each of the edge locations, an extent of activity of the AI and/or ML models over the predetermined period of deployment, wherein the extent of activity is based on central processing unit (CPU) utilization and/or graphics processing unit (GPU) utilization.

15. The CPP of claim 9, wherein estimating the future operation efficiencies of the AI and/or ML models deployed on the edge locations includes: identifying, in a predetermined type of report, trends of development of condition(s) in the edge locations; logically re-grouping the edge locations based on the identified trends; checking an extent of development of fulfillment of an associated service level agreement (SLA) within a predetermined amount of time; and correlating the re-grouped edge locations with historical groupings, wherein the estimated future operation efficiencies of the AI and/or ML models are based on the correlation.

16. The CPP of claim 15, wherein identifying the trends of development of condition(s) in the edge locations includes causing predetermined generative AI models to review domain condition reports and/or AI and ML reports to identify the trends.

17. A computer system (CS), the CS comprising:
a processor set;
a set of one or more computer-readable storage media; and
program instructions, collectively stored in the set of one or more storage media, for causing the processor set to perform the following computer operations:
logically group edge locations of a telecommunication network into different groups based on characteristics of the edge locations;
identify, for each of the edge locations, operation baselines of artificial intelligence (AI) and/or machine learning (ML) models over a predetermined period of deployment of the models on the edge locations of the telecommunication network;
estimate, based on the operation baselines, future operation efficiencies of the AI and/or ML models deployed on the edge locations;
determine a first update for increasing a first of the future operation efficiencies of the AI and/or ML models; and
cause the first update to be performed within the telecommunication network.

18. The CS of claim 17, wherein the first update includes reconfiguring models of the AI and/or ML models.

19. The CS of claim 17, wherein the characteristics of the edge locations are selected from the group consisting of: whether a majority of users of a given one of the edge locations are using ultra reliable low-latency communications (uRLLC), whether a majority of users of a given one of the edge locations are using enhanced mobile broadband (eMBB) services, whether a majority of users of a given one of the edge locations are using massive Machine Type Communications (mMTC), an availability of resources for storage at a given one of the edge locations, and an availability of spectrum at a given one of the edge locations.

20. The CS of claim 17, wherein identifying the operation baselines of AI and/or ML models includes identifying, for each of the edge locations, an extent of development of fulfillment of an associated service level agreement (SLA) within a predetermined amount of time.
